(19) United States
(12) Patent Application Publication
(10) Pub. No.: US 2007/0003341 A1
(43) Pub. Date: Jan. 4, 2007

(54) Image processing device, image processing method, program, and recording medium

(76) Inventors: Haike Guan, Kanagawa (JP); Masaaki Ishikawa, Tokyo (JP); Hiroshi Shimura, Kanagawa (JP); Taeko Ishizu, Saitama (JP); Hiroyuki Yoshida, Tokyo (JP)

Correspondence Address: DICKSTEIN SHAPIRO LLP, 1825 EYE STREET NW, Washington, DC, 20006-5403, US

(21) Appl. No.: 11/471,600

(22) Filed: Jun. 21, 2006

(30) Foreign Application Priority Data
Jun. 22, 2005 (JP) 2005-182297
May 30, 2006 (JP) 2006-150409

(51) Int. Cl. G03G 21/00

(52) U.S. Cl. 399/366

(57) ABSTRACT

In an image processing device which extracts predetermined information from a paper document in which the predetermined information is embedded, and performs a predetermined process in accordance with the extracted information and a request from a user, an attribute judgment unit determines an attribute of the paper document from the extracted information. A certification-information acquisition unit acquires certification information including an attribute of the user. A control unit performs a predetermined process based on the attribute of the paper document and the certification information.

### BACKGROUND OF THE INVENTION

1. Field of the Invention

The present invention relates to an image processing device, an image processing method, a computer-readable image processing program, and a computer-readable recording medium, which are adapted for prevention of illegal copying.

2. Description of the Related Art

In recent years, with the improvements in image processing technology and image formation technology, if copying of bank notes, negotiable securities, etc. is performed using a digital color copier, a faithful copy can be created such that one cannot easily distinguish a difference between the copy and the original.

For this reason, it is necessary to take preventive measures for completely inhibiting illegal copying of the special original documents, such as bank notes or negotiable securities, or for preventing such special original documents from being copied correctly.

Moreover, from a viewpoint of the security protection of the contents of documents in companies, there are many confidential documents copying of which is forbidden even in business documents other than the special original documents, such as bank notes or negotiable securities. Thus, it is also necessary to take preventive measures for completely inhibiting illegal copying of such confidential documents or for preventing such confidential documents from being copied correctly.

Conventionally, various methods which are adapted for preventing illegal copying of the special original documents or the confidential documents have been proposed and known.

One of such methods is a method of distinguishing the special original documents, such as bank notes or negotiable securities, as disclosed in Japanese Laid-Open Patent Application No. 06-125459 or Japanese Laid-Open Patent Application No. 2001-086330. In this method, the input image data of an original document are compared with a specific mark (pattern data) registered beforehand by using the pattern matching, and when the specific mark exists in the input image data, it is judged that the original document is a special original document. According to this method, copying of the original document is inhibited when it is judged that the original document is a special original document.

Another of the above methods is a method of distinguishing the confidential documents, as disclosed in Japanese Laid-Open Patent Application No. 07-036317 or Japanese Laid-Open Patent Application No. 07-087309. In this method, a predetermined mark indicating that the original document is a confidential document is attained to the confidential document, and it is detected whether the input image data of the original document contains the predetermined mark. This method utilizes the practice in which secret seals, copy-inhibition marks or the like, indicating that the document is a confidential document, are imprinted on the confidential documents generally. In this way, copying of the original document is inhibited when it is judged that the original document is a confidential document.

Still another of the above methods is a method of preventing copying of a document by embedding a ground tint in the original image of the document, as disclosed in Japanese Laid-Open Patent Application No. 09-164739 or Japanese Laid-Open Patent Application No. 2001-197297. This method utilizes the sheet carrying the original image in which a ground-tint pattern is created, the background of the original image including a base region and a message region.

The ground-tint pattern is not so much conspicuous in the original image, and does not cause trouble on legibility of the information included in the original image. However, if the original image in which the ground-tint pattern is embedded is copied, the pattern of the message region appears on the reproduced document image.

For example, if the characters “copy inhibition” are given as the ground-tint pattern of the message region, it will be quite obvious that the copy was made from a secret document of copy inhibition, and the restraining effect to prevent copying of confidential document mentally can be created.

Moreover, Japanese Laid-Open Patent Application No. 2004-274092 discloses another method of preventing copying of documents. In this method, a pattern (e.g., a dot pattern) which indicates specific information is superimposed on a surface of an original document being recorded as the original image, and if the superimposed pattern is detected when reading the original image, the outputting of the original image is inhibited.

In the case of the above-mentioned conventional methods, it is possible that the pattern indicating the specific information is made to appear or the outputting of the original image is inhibited if illegal copying is conducted. However, even if any of the case of the above-mentioned conventional methods is used, the method provides only a fixed illegal copying prevention process with respect to an original image, and the user is not allowed to select an appropriate one from among a number of illegal copying prevention processes.

### SUMMARY OF THE INVENTION

According to one aspect of the invention, there is provided an improved image process device and method in which the above-described problems are eliminated.

According to one aspect of the invention, there is provided one of an image processing device, an image processing method, a computer-readable image processing program, and a computer-readable recording medium which are adapted for prevention of illegal copying.

In an embodiment of the invention which solves or reduces one or more of the above-mentioned problems, there is provided an image processing device which extracts predetermined information from a paper document in which the predetermined information is embedded, and performs a predetermined process in accordance with the extracted information, the image processing device comprising: an attribute judgment unit determining an attribute of the paper document from the extracted information; a certification-information acquisition unit acquiring certification information; and a control unit performing a predetermined process based on the attribute of the paper document and the certification information. The certification information may include attributes of a user who requests document copying.

The above-mentioned image processing device may be configured so that the image processing device is provided with a storage unit storing image data of an image of the paper document.

The above-mentioned image processing device may be configured so that, when it is determined, based on the attribute of the paper document and the certification information, that performance of the predetermined process to the paper document is inhibited, the control unit is provided to output an image of the paper document which is made illegible.

The above-mentioned image processing device may be configured so that the predetermined information includes original-image-related information which relates to the paper document, and the control unit is provided to store the original-image-related information into the storage unit.

The above-mentioned image processing device may be configured so that the attribute of the paper document includes a security level which is indicative of whether performance of the predetermined process is inhibited or not, in accordance with the certification information, and the control unit is provided to determine whether performance of the predetermined process to the paper document is inhibited, based on the security level and the certification information.

The above-mentioned image processing device may be configured so that, when it is determined that performance of the predetermined process to the paper document is inhibited, the control unit is provided to perform a predetermined notification.

In an embodiment of the invention which solves or reduces one or more of the above-mentioned problems, there is provided an image processing method for an image processing device which extracts predetermined information from a paper document in which the predetermined information is embedded, and performs a predetermined process in accordance with the extracted information, the image processing method comprising the steps of: determining an attribute of the paper document from the extracted information; acquiring certification information; and performing a predetermined process based on the attribute of the paper document and the certification information. The certification information may include attributes of a user who requests document copying.

The above-mentioned image processing method may be configured so that the image processing device is provided with a storage unit storing image data of an image of the paper document.

The above-mentioned image processing method may be configured so that, when it is determined, based on the attribute of the paper document and the certification information, that performance of the predetermined process to the paper document is inhibited, the step of performing the predetermined process is provided to output an image of the paper document which is made illegible.

The above-mentioned image processing method may be configured so that the predetermined information includes original-image-related information which relates to the paper document, and the step of performing the predetermined process is provided to store the original-image-related information into the storage unit.

The above-mentioned image processing method may be configured so that the attribute of the paper document includes a security level which is indicative of whether performance of the predetermined process is inhibited or not, in accordance with the certification information, and the step of performing the predetermined process is provided to determine whether performance of the predetermined process to the paper document is inhibited, based on the security level and the certification information.

The above-mentioned image processing method may be configured so that, when it is determined that performance of the predetermined process to the paper document is inhibited, the step of performing the predetermined process is provided to perform a predetermined notification.

In an embodiment of the invention which solves or reduces one or more of the above-mentioned problems, there is provided a computer-readable program which, when executed by a computer, causes the computer to perform an image processing method for an image processing device which extracts predetermined information from a paper document in which the predetermined information is embedded, and performs a predetermined process in accordance with the extracted information, the method comprising: determining an attribute of the paper document from the extracted information; acquiring certification information; and performing a predetermined process based on the attribute of the paper document and the certification information. The certification information may include attributes of a user who requests document copying.

In an embodiment of the invention which solves or reduces one or more of the above-mentioned problems, there is provided a computer-readable recording medium having a program stored therein which, when executed by a computer, causes the computer to perform an image processing method for an image processing device which extracts predetermined information from a paper document in which the predetermined information is embedded, and performs a predetermined process in accordance with the extracted information, the method comprising: determining an attribute of the paper document from the extracted information; acquiring certification information; and performing a predetermined process based on the attribute of the paper document and the certification information.

According to the embodiments of the invention, it is possible to provide one of an image processing device, an image processing method, a computer-readable image processing program, and a computer-readable recording medium which are adapted appropriately for prevention of illegal copying.

### BRIEF DESCRIPTION OF THE DRAWINGS

Other objects, features and advantages of the present invention will be apparent from the following detailed description when reading in conjunction with the accompanying drawings.

FIG. 1 is a diagram showing an example of an original image.

FIG. 2 is a diagram showing an example of the copy of the original image in which a ground-tint pattern embedded in the original image is made visible.

FIG. 3 is a diagram showing an example of the copy of the original image in which a ground-tint pattern embedded in the original image is made visible.

FIG. 4A and FIG. 4B are diagrams showing the composition of the ground-tint pattern shown in FIG. 3.

FIG. 5A and FIG. 5B are diagrams showing the composition of the ground-tint pattern shown in FIG. 2.

FIG. 6 is a diagram showing an example of a basic pattern.

FIG. 7 is a diagram showing an example of an additional pattern.

FIG. 8 is a diagram for explaining an example of the array of the patterns and the information expressed in this example.

FIG. 9 is a diagram for explaining an example of the array of the patterns and the information expressed in this example.

FIG. 10 is a diagram for explaining an example of the array of the patterns and the information expressed in this example.

FIG. 11 is a diagram for explaining the format of the basic pattern for each stage when the angle is quantized into six stages.

FIG. 12 is a diagram for explaining the format of the additional pattern for each stage when the angle is quantized into six stages.

FIG. 13 is a diagram showing an example of the information expressed by the absolute or relative angle and the array of the patterns.

FIG. 14 is a diagram showing an example of the information expressed by the absolute or relative angle and the array of the patterns.

FIG. 15 is a diagram showing an example of the information expressed by the absolute angle and the array of the patterns.

FIG. 16 is a block diagram showing the hardware composition of an image processing device in an embodiment of the invention.

FIG. 17 is a block diagram showing the composition of a pattern detecting unit.

FIG. 18 is a block diagram showing the hardware composition of an image processing device in another embodiment of the invention.

FIG. 19 is a block diagram showing the hardware composition of an image processing device in another embodiment of the invention.

FIG. 20 is a flowchart for explaining the processing which is performed by the image processing device of the invention according to the information embedded in the original image.

FIG. 21 is a diagram showing an example of a table used in a certification-information judgment process.

FIG. 22 is a diagram showing an example of original-image-related information which relates to a paper document.

### DETAILED DESCRIPTION OF PREFERRED EMBODIMENTS

A description will now be given of embodiments of the invention with reference to the accompanying drawings.

In the following, a paper document is referred to as an original image. The original image and a method of extracting predetermined information from the original image in which the predetermined information is embedded will be explained first. Then, the composition of an image processing device in an embodiment of the invention, and an image processing method performed by the image processing device will be explained subsequently.

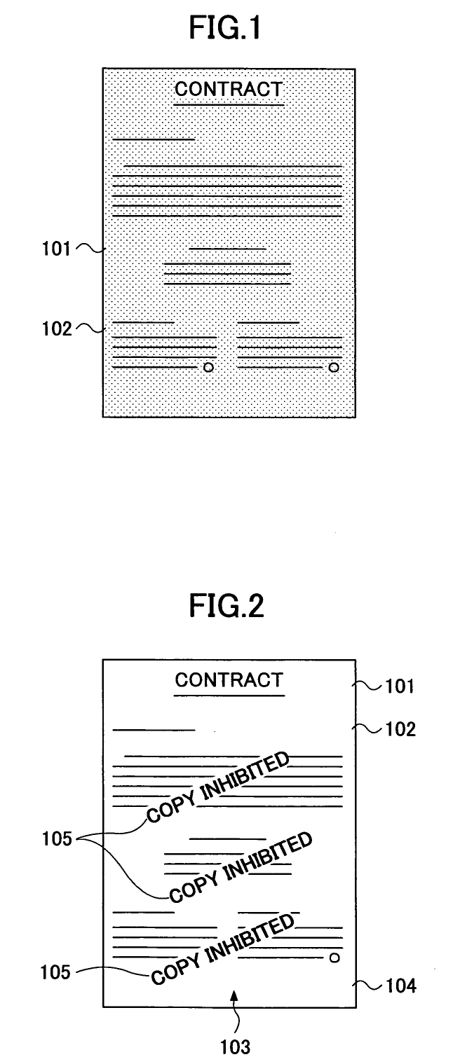

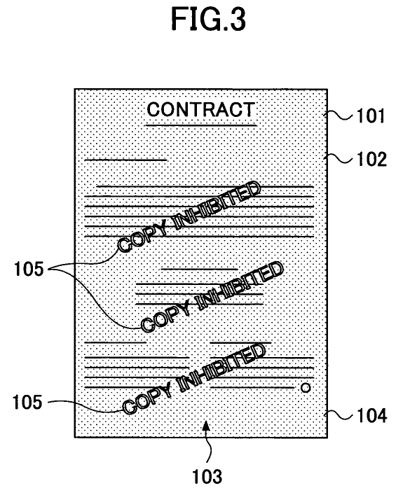

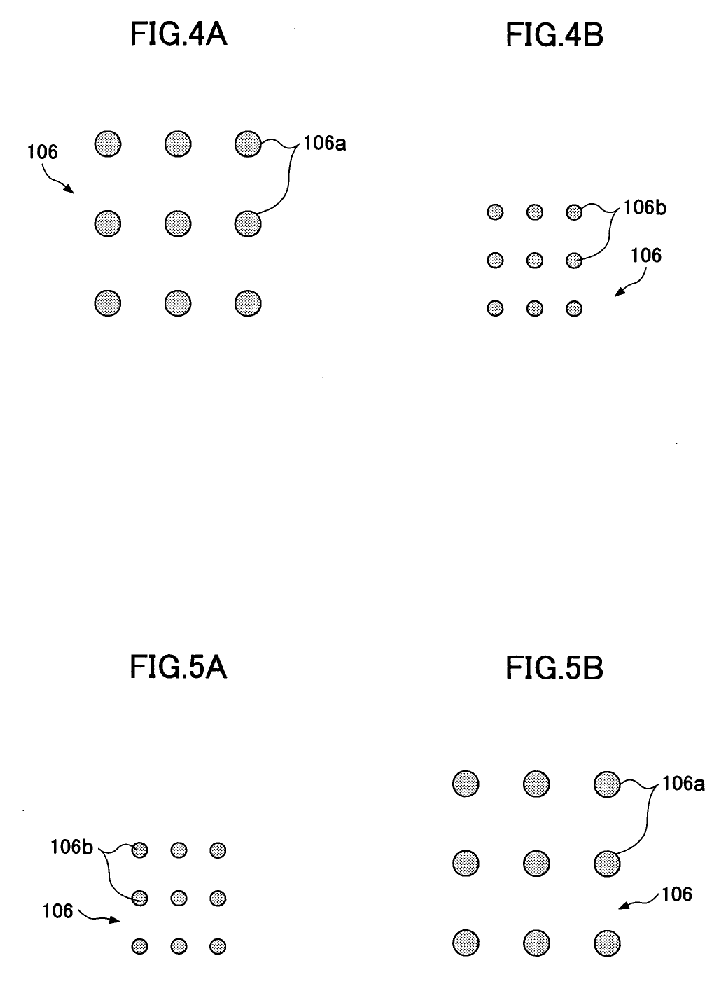

Referring to FIG. 1 through FIG. 5B, a description will be given of the original image. FIG. 1 shows an example of the original image. FIG. 2 shows an example of the copy of the original image in which a ground-tint pattern embedded in the original image is made visible after the copying. FIG. 3 shows another example of the copy of the original image in which a ground-tint pattern embedded in the original image is made visible. FIG. 4A and FIG. 4B show the composition of the ground-tint pattern shown in FIG. 3. FIG. 5A and FIG. 5B show the composition of the ground-tint pattern shown in FIG. 2.

In the example of FIG. 1, the original image 101 is a contract document, and the original sheet 102 is used as the sheet of the original image 101. In the background portion of the original sheet 102, the ground-tint pattern 103 (background dot pattern) is embedded as shown in FIG. 2.

Alternatively, the original sheet in which the ground-tint pattern 103 is not embedded may be used. In such alternative case, the ground-tint pattern 103 may be formed simultaneously when forming the original image 101 (the contract document).

That is, the ground-tint pattern 103 may be formed beforehand in the original sheet 102 by performing a printing process. Or the ground-tint pattern 103 may be formed on the original sheet 102 simultaneously when forming images of characters, drawings, etc. on the original sheet 102.

The ground-tint pattern 103 includes a base region 104 and message regions 105. The base region 104 is the background portion which occupies the most part of the original sheet 102. The message regions 105 are the areas distributed in the base region 104 and used to express the message concerned. In the example of FIG. 2, each of the message regions 105 contains the characters “copy inhibited”. Instead of the characters, any of a drawing, a character or a sign which indicate a date, a document number or a company LOGO, may be contained in the message region 105.

If copying of the original image 101 which is created using the original sheet 102 mentioned above is performed, the part of the ground-tint pattern 103 of the original image 101 appears in the reproduced image. In the case of the original image 101 of FIG. 2, the message regions 105 indicating the characters “copy inhibited” emerge after the copying and the base region 104 is left in white. In the case of the original image 102 of FIG. 3, the base region 104 emerges after the copying and the message regions 105 indicating the characters “copy inhibited” are left in white.

For example, the ground-tint pattern 103 is constituted by a set of dots 106 including two kinds of dots with different sizes, as shown in FIG. 4A through FIG. 5B. Of the two kinds of the dots 106, the small dots 106b are difficult to be copied or reproduced, and the large dots 106a are easy to be copied or reproduced. For this reason, in the case of the ground-tint pattern 103 shown in FIG. 2, the small dots 106b are used on the base region 104 side and the large dots 106a are used on the message region 105 side as shown in FIG. 5A and FIG. 5B. On the other hand, in the case of the ground-tint pattern 103 shown in FIG. 3, the small dots 106b are used on the message region 105 side and the large dots 106a are used on the base region 104 side as shown in FIG. 4A and FIG. 4B.

Alternatively, the ground-tint pattern 103 (the message regions 105 or the base region 104) may be constituted by a thin line pattern, a specific textured pattern, etc., instead of a dot pattern.

In such embodiments, the message region 105 or the base region 104 is treated as a characteristic amount. For example, if the message region 105 or the base region 104 which emerges after copying is constituted by the dots 106, the dot size or the dot density (the number of dots per unit area) may be used as a characteristic amount. If the message region 105 or the base region 104 which emerges after copying is constituted by a thin line pattern, the width of the line may be used as a characteristic amount. If the message region 105 or the base region 104 which emerges after copying is constituted by a specific textured pattern, the feature of the pattern may be used as a characteristic amount.

In the above examples, the characteristic amount which relates to the message region 105 or the base region 104 have been described. Alternatively, each of the characteristic amounts which relate to the base region 104 and the message region 105 may be determined respectively. In other words, if either or both of the base region 104 and the message region 105 can be read as data when reading the original image 101 including the image data with the ground-tint pattern 103 being embedded, it is possible to treat the readable data as the characteristic amount.

In the case of the image data in which the ground-tint pattern 103 in the form of data is embedded, if either or both of the base region 104 and the message region 105 which constitute the ground-tint pattern 103 can be read as data, it is possible to treat the readable data as the characteristic amount.

As the background dot pattern, another pattern other than the ground-tint pattern 103 may be also used. For example, a pattern only equivalent to the base region 104 in the ground-tint pattern 103 or a pattern only equivalent to the message region 105 in the ground-tint pattern 103 may be used. If the base region 104 or the message region 105 can be read as data when reading the original image 101 including the pattern equivalent to the base region 104 or the pattern equivalent to the message region 105, it is possible to treat the readable data as the characteristic amount.

There is also the case where the image data of the original image 101 including the ground-tint pattern 103 constitute a color image containing two or more colors. In such a case, the ground-tint pattern 103 is detected based on a predetermined color component in a predetermined color space (RGB space and CMY space) of the image data of the original image 101.

Usually, many images that are read from original documents by a scanner are RGB images. Thus, in order to detect the ground-tint pattern 103 in CMY space, the image data of the RGB images of the original image 101 are transformed into CMY space and the detection of the ground-tint pattern 103 is performed using the characteristic amount based on the color component (C, M, Y or K) in CMY space of the transformed image data.

On the other hand, in order to detect the ground-tint pattern 103 in RGB space, the color transformation is not performed and the detection of the ground-tint pattern 103 is performed using the characteristic amount based on one color component (R, G, or B) of the image data in RGB space. However, it is not necessary to make the detection based on one color component, and the detection of a candidate pattern in other color components may be performed simultaneously. In addition, it is possible that the ground-tint pattern 103 is detected in each of the color components, and a security level (a restriction level of a user who is permitted to perform copying) may be varied depending on which of the color components in which the ground-tint pattern 103 is detected.

In this manner, the ground-tint pattern 103 is detected based on the predetermined color component in the predetermined color space. Even in the case where the ground-tint pattern 103 is added in a light color, an appropriate level of detection accuracy can be maintained. When detecting the ground-tint pattern 103 in RGB space, it is not necessary to perform the color transformation, and the speed of processing can be improved.

Next, a method of extracting predetermined information from the original image (paper document) in which the predetermined information is embedded using a predetermined pattern will be explained.

The base region 104 is used as the area where the predetermined information is embedded. This is because the base region 104 has a large area when compared with the message region 105 and it is usually appropriate for the embedding of information and the extraction thereof.

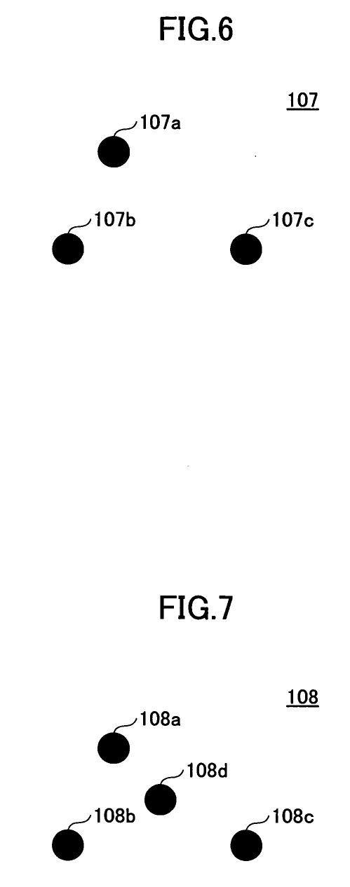

In the following, the predetermined information may be expressed using the relative spatial relationship of the two kinds of patterns shown in FIG. 6 and FIG. 7, instead of the dot patterns shown in FIGS. 4A-5B. One of the two kinds of patterns is referred to as “basic pattern”, and the other is referred to as “additional pattern”.

FIG. 6 shows an example of the basic pattern. As shown in FIG. 6, the basic pattern 107 comprises three dots 107a, 107b, and 107c. FIG. 7 shows an example of the additional pattern. As shown in FIG. 7, the additional pattern 108 comprises four dots 108a, 108b, 108c, and 108d. It is desirable that the characteristic amount of the additional pattern 108 and the characteristic amount of the basic pattern 107 are partially common to each other. In this embodiment, it is supposed that the relative spatial relationship of the dots 108a, 108b, and 108c is the same as that of the three dots of the basic pattern 107. Namely, the additional pattern 108 is prepared by adding the dot 108d to the basic pattern 107. The number of dots and the relative spatial relationship of the dots in the basic pattern 107 and the additional pattern 108 are not limited to those shown in FIG. 6 and FIG. 7. What is necessary is just that distinguishing between the basic pattern 107 and the additional pattern 108 is possible.

The predetermined information is expressed using either the relative angle of the basic pattern 107 and the additional pattern 108 or the relative spatial relationship of the basic pattern 107 and the additional pattern 108 as the relative relation of the two kinds of patterns.

First, an example in which predetermined information is expressed using the relative spatial relationship of the two kinds of patterns will be explained. The relative spatial relationship in this case means the array of the patterns (the manner or the sequence in which the patterns are arranged). That is, the predetermined information is expressed depending on the manner one or more basic patterns 107 and one or more additional patterns 108 are arranged.

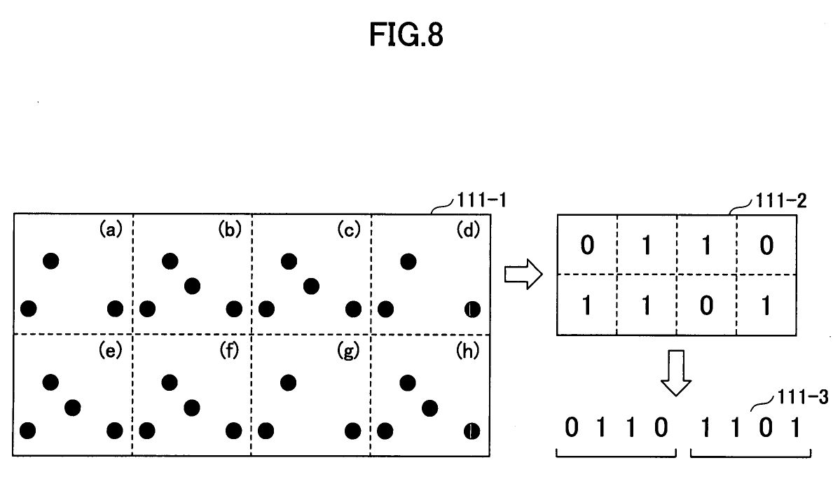

FIG. 8 shows an example of the array of the patterns and the information expressed in this example. As shown in FIG. 8, the array 111-1 is constituted by arranging the unit areas where one pattern is contained in two rows and four columns. In each unit area, either the basic pattern 107 or the additional pattern 108 is arranged.

In the example of FIG. 8, the basic pattern 107 is arranged at each of the unit areas (a), (d) and (g), and the additional pattern 108 is arranged at each of the other unit areas. For example, suppose that data “0” is assigned to each basic pattern 107 and data “1” is assigned to each additional pattern 108. From the array 111-1 in this example, the array 111-2 of 0s and is can be obtained. If the elements of the array 111-2 are rearranged in order of the upper line first and the lower line second, the digital information 111-3 having the eight binary digits “01101101” will be acquired as shown in FIG. 8. Therefore, 8-bit information can be embedded by superimposing the array 111-1 on the original image 101.

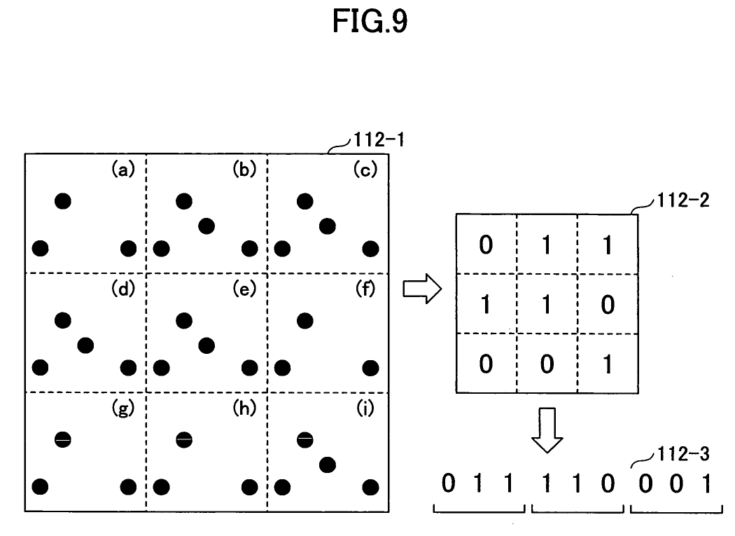

FIG. 9 shows an example of the array of the patterns and the information expressed in this example. As shown in FIG. 9, the array 112-1 comprises unit areas arranged in three columns and three rows. In this example, the basic pattern 107 is arranged at each of the unit areas (a), (f), (g) and (h) and the additional pattern 108 is arranged at each of the other unit areas.

Following the method of FIG. 8, the array 112-1 is changed to the array 112-2 and the digital information 112-3 (“011110001”) will be acquired. Therefore, 9-bit information can be embedded by superimposing the array 112-1 on the original image 101.

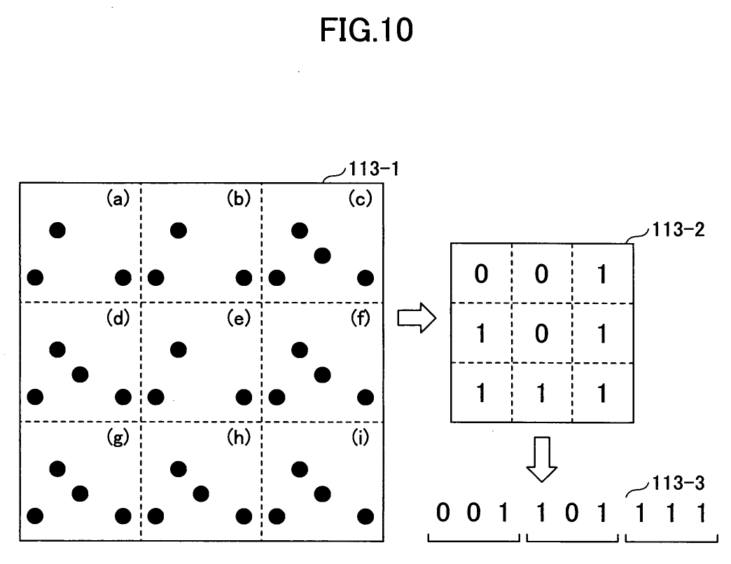

FIG. 10 shows an example of the array of the patterns and the information expressed in this example. As shown in FIG. 10, the array 113-1 comprises the unit areas arranged in three columns and three rows, which is the same as the array 112-1 of FIG. 9, but the contents of the array differ. That is, the basic pattern 107 is arranged at each of the unit areas (a), (b) and (e) and the additional pattern 108 is arranged at each of the other unit areas. The array 113-2 is obtained from the array 113-1, and the digital information 113-3 (“001101111”) will be acquired. As is apparent from the examples of FIGS. 8, 9 and 10, the amount of information that can be embedded when arranging the patterns depends on the number of unit areas. That is, the formula I=n (bits) is obtained, supposing that “I” denotes the amount of information and “n” denotes the number of unit areas.

It is desirable that the array of the patterns is prepared by superimposing the same patterns repetitively twice or more. This is because a possibility that an array will be detectable increases and the detecting accuracy of information can be raised the place which can consider that detection of a pattern becomes difficult by a relation with original image 101 depending on the position where it is superimposed on an array, if more than one are made to superimpose.

Although the example which uses two kinds of patterns of basic pattern 107 and additional pattern 108 above was explained, three or more kinds of patterns may be used.

If the patterns of N kinds are used, in each unit area, the information consisting of “log N” bits (the bottom is 2) can be embedded. Therefore, the amount of information (I) for one array of the patterns is represented by the formula: I=n×log N (bits) where n denotes the number of unit areas. It is possible that a larger amount of information be embedded.

The difference in the kind of pattern is not restricted only to arrangement of dots, for example, may use the color of a dot. That is, even if completely the same as arrangement of a dot, it may distinguish from other patterns by the color of the part which constitutes each pattern, or all dots.

Of course, the kind may be distinguished with the combination of the arrangement of dots and the color of dots.

Next, an example in which predetermined information is embedded using the relative angle of the two kinds of patterns will be explained.

When a relative angle expresses information, it is desirable from a viewpoint of improvement in the extraction precision of information to quantize the angle which basic pattern 107 and additional pattern 108 can take.

In this embodiment, when the angle of 360 degrees is quantized into six stages, the case where it is made to rotate by a unit of 60 degrees is explained as an example.

FIG. 11 shows the format of the basic pattern in each stage at the time of quantizing the angle into six stages. Suppose that the stages are called from the left, zero stage, one stage, two stage, three stage, four stage, and five stage as shown in FIG. 11. The arrow in the circle in each stage in FIG. 11 is shown as a guide, in order to express the direction (angle) in each stage intelligibly.

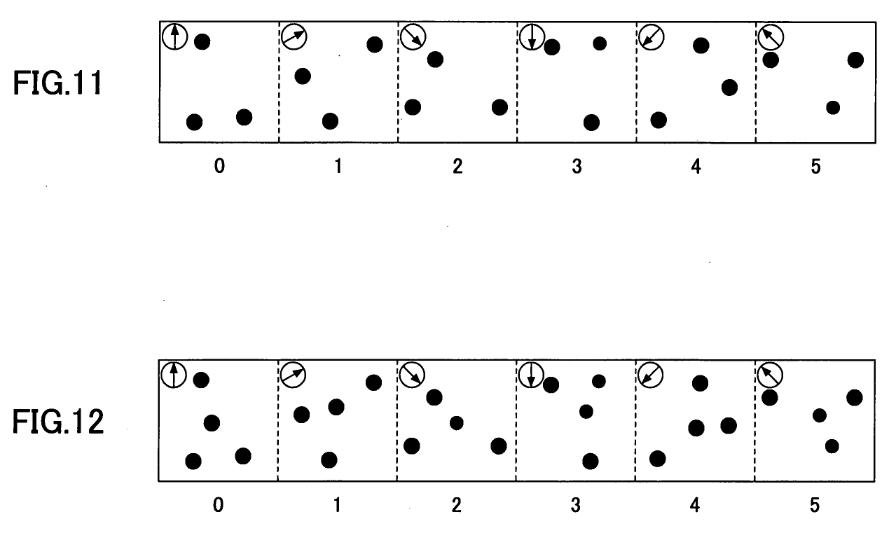

FIG. 12 shows the format of the additional pattern in each stage at the time of quantizing the angle into six stages.

Since it is the relative angle, predetermined information can be expressed by which of the stages at which the basic pattern 107 differs from the additional pattern 108. For example, suppose that the difference in N stage is expressed as the numeric value N as it is. In this case, “0” can be expressed by making the same the direction of basic pattern 107 and additional pattern 108. The relative angles (the difference in the direction) of one stage, two stage, three stage, four stage, and five stage can be expressed as “1”, “2”, “3”, “4”, and “5”. Since it is the relative angle, there are two or more states of expressing the value “1”. That is, when the basic pattern 107 is each stage of 0, 1, 2, 3 and 4, “1” will be expressed if the additional pattern 18 is 1, 2, 3, 4, and 5 stages. The same may be applied in expressing another value.

When only a relative angle expresses information, it is not related whether which position of base region 104 is overlapped on basic pattern 107 and additional pattern 108. At least one should just be superimposed on the both sides of basic pattern 107 and additional pattern 108. If “n” denotes the number of stages of quantization, the amount of information (I) which can be embedded in the original image 101 is represented by the formula: I=log n (bits).

Since the examples of FIG. 11 and FIG. 12 are quantized into the six stages and the condition I=log 6=2.4 . . . >=2 (bits) is met, the amount of information which can be embedded is 2 bits or more.

In the above-mentioned example, the respective angles (directions) of the patterns to the original image 101 are not taken into consideration and only the relative angle of the basic pattern 107 and the additional pattern 108 is taken into consideration. This is because the realistic situation is that an error may arise in the direction of the sheet in the case of reading of the original image 101 by the scanner and outputting of the image data to a paper document. Namely, when taking into consideration only the relative angle of both the patterns, the relative angle cannot be influenced even if the original image 101 rotates in either direction, and the level of accuracy of extracting the embedded information can be raised.

However, if the direction of the original image 101 is secured to be in a certain amount, the absolute angle of each pattern to the original image 101 may be taken into consideration. In this case, even if the relative angle of both the patterns is the same, still another information can be expressed by the absolute angle of the basic pattern 107 to the original image 101. Therefore, supposing that “n” denotes the number of stages in which the absolute angle is quantized, the amount of information (I) which can be embedded in the original image 101 is represented by the formula: I=n×log n (bits).

Moreover, the predetermined information may be expressed by combination of the relative spatial relationship (array) of the patterns, the relative angle of the patterns, and the absolute angles of the patterns.

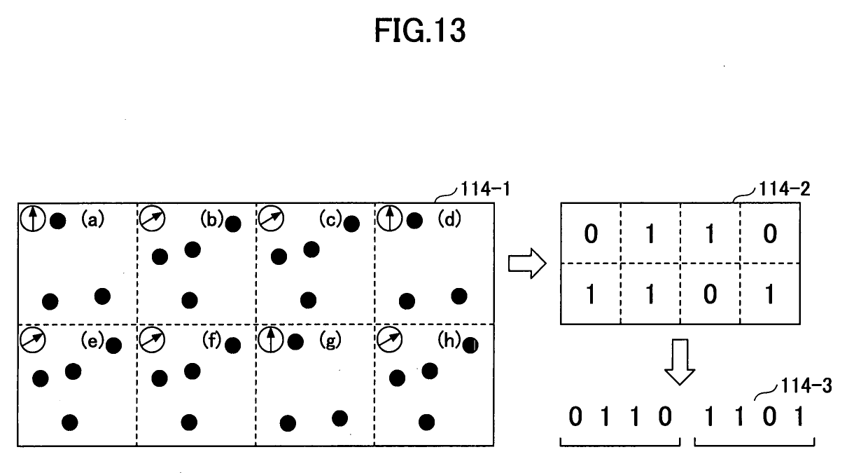

FIG. 13 shows an example of the information expressed by the array of the patterns and the absolute or relative angle. As shown in FIG. 13, the array 114-1 comprises the unit areas arranged in four columns and two rows. The basic pattern 107 is arranged at each of the unit areas (a), (d) and (g), and the additional pattern 108 is arranged at each of the other unit areas. When considering the relative angle, the difference between the angles of both the patterns is one stage. Suppose that data “0” is assigned to the basic pattern 107. Then, the array 114-2 is obtained from the array 114-1, and the digital information 114-3 (“01101101”) will be acquired further.

When considering the absolute angles, the angle of the basic pattern 107 is zero stage, and the angle of additional pattern 108 is one stage. In this case, the same digital information 114-3 as that mentioned above will be acquired.

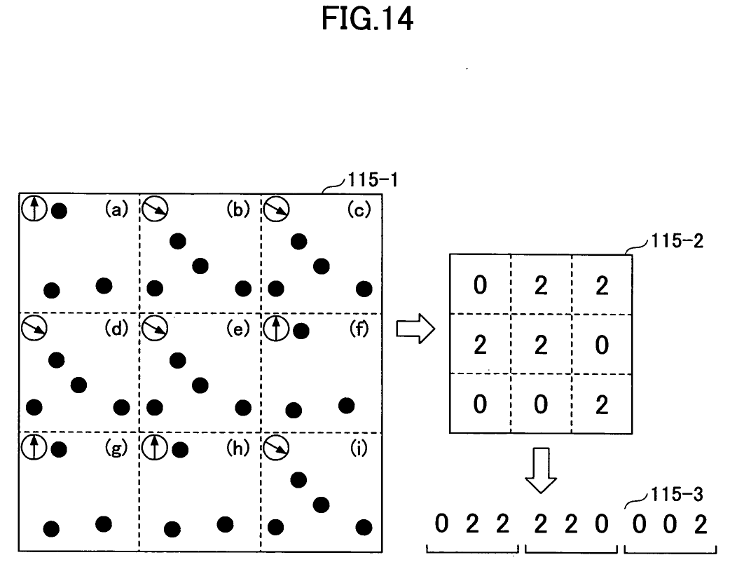

FIG. 14 shows an example of the information expressed by the absolute or relative angle and the array of the patterns. As shown in FIG. 14, the array 115-1 comprises the unit areas arranged in three columns and three rows. In this example, the basic pattern 107 is arranged at each of the unit areas (a), (f), (g) and (h), and the additional pattern 108 is arranged at each of the other unit areas. The difference between the angles of both the patterns is two stage. Similar to the example of FIG. 13, in each of the cases of considering the relative angle and considering the absolute angles, the array 115-2 is obtained from the array 115-1, and the digital information 115-3 (“022220002”) will be acquired further.

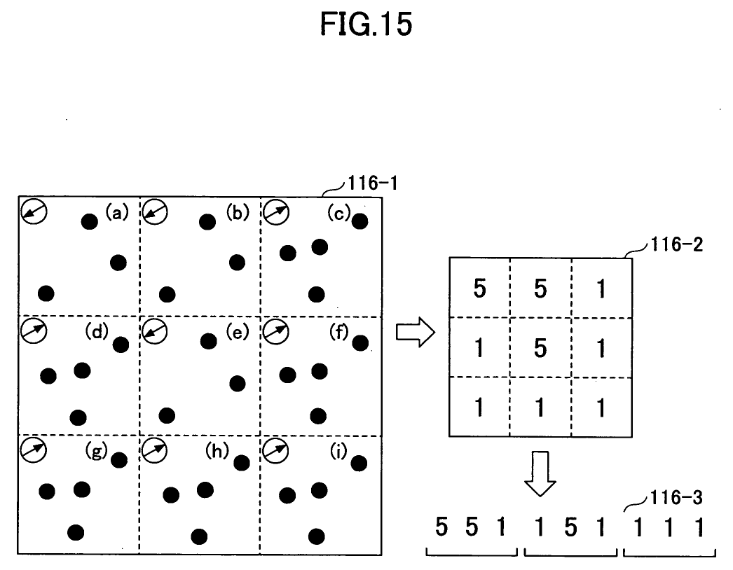

FIG. 15 shows an example of the information expressed by the array of the patterns and the absolute angles. As shown in FIG. 15, the array 116-1 comprises the unit areas arranged in three columns and three rows. In this example, the basic pattern 107 is arranged at each of the unit areas (a), (b) and (e), and the additional pattern 108 is arranged at each of the other unit areas. Considering only the absolute angles, the angle of the basic pattern 107 is five stage, and the angle of the additional pattern 107 is one stage. Therefore, the array 116-2 is obtained from the array 116-1, and the digital information 116-3 (“551151111”) will be acquired further.

As described above, if the array of the patterns is combined with the absolute or relative angle of the patterns, the amount of information which is “m” times as much as the previously mentioned amount of information (“m” denotes the number of unit areas) can be expressed.

Moreover, three or more kinds of patterns may be used. When the patterns of N kinds are used, the amount of information (I) which is N times as much as the previously mentioned amount of information can be expressed.

The difference in the kind of patterns is not restricted only to the arrangement of dots, and it is applicable to the color of dots. Namely, even when the arrangement of dots is exactly the same, it may distinguish from other patterns by the colors of all or part of the dots which constitute each pattern. Of course, the kind of patterns may be distinguished by combination of the arrangement of dots and the color of dots.

When the above-mentioned method of embedding the information on the original image is used, the size of each pattern may be set to several millimeters. Hence, it is possible for the above-mentioned method to embed hundreds of bytes of information in the original image per sheet.

By making use of the above-mentioned method, the image processing device, the image processing method, and the image processing program according to the invention which extract predetermined information from a paper document in which the predetermined information is embedded will be explained.

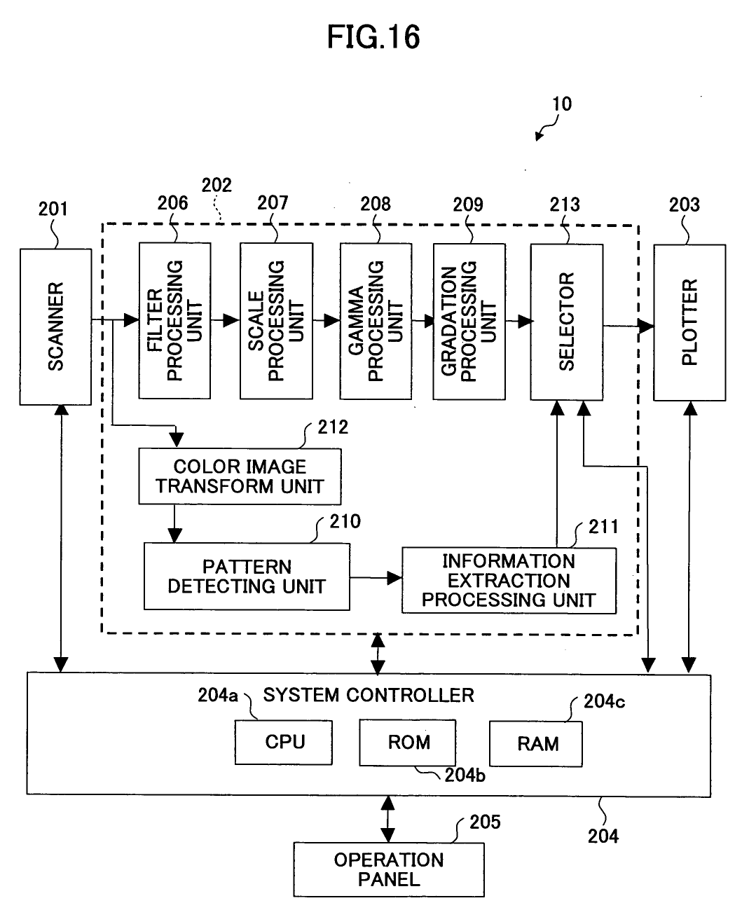

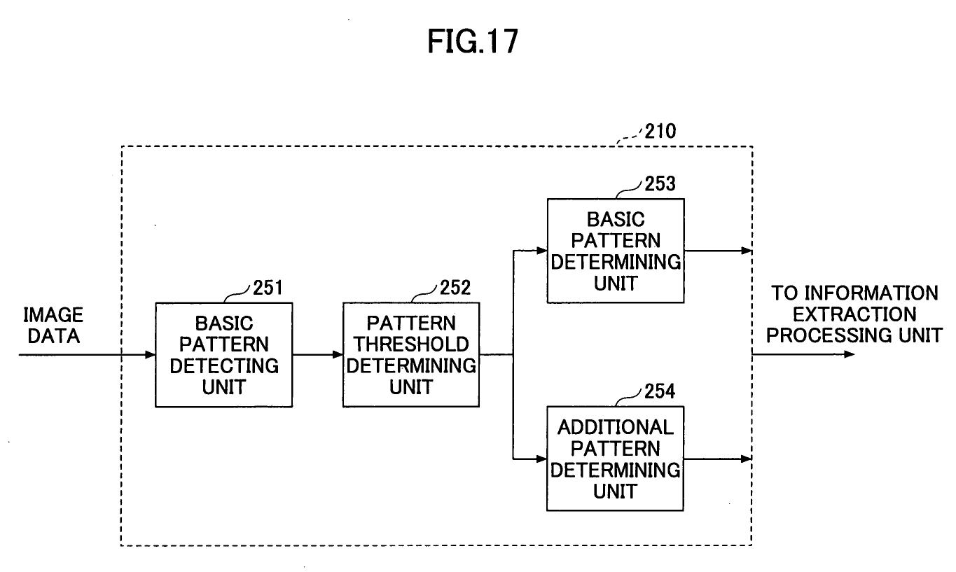

FIG. 16 is a block diagram showing the hardware resources of an image processing device in an embodiment of the invention. FIG. 17 is a block diagram of a pattern detecting unit.

As shown in FIG. 16, the image processing device 10 of this embodiment is considered to have the composition of a digital copier. In this image processing device 10, a system controller 204 controls a scanner 201 provided as an image reader, an image processing unit 202 constituted by a digital circuit, and a plotter 203. The system controller 204 is constituted by the computer functions including a CPU (Central Processing Unit) 204a, a ROM (Read Only Memory) 204b, a RAM (Random Access Memory) 204c, etc. In accordance with a request sent from an operation panel 205 by the user, the system controller 202 controls the scanner 201, the image processing unit 202, and the plotter 203, and the requested information is returned and displayed on the operation panel 205. Although not illustrated in FIG. 16, the image processing device 10 further comprises a non-volatile storage device, such as a hard disk, a flash memory, or a non-volatile-RAM.

The image processing unit 202 includes a filter processing unit 206, a scale processing unit 207, a gamma processing unit 208, and a gradation processing unit 209. These elements of the image processing unit 202 are essentially the same as corresponding elements of a known digital copier, and a description thereof will be omitted.

The image processing unit 202 of this embodiment further comprises a pattern detecting unit 210, an information extraction processing unit 211, a color image transform unit 212, and a selector 213. These elements are the hardware constituted by a digital circuit and provided to extract predetermined information from the original image in which the predetermined information is embedded.

The original image 101 is read from a paper by the scanner 201. The original image 101 is subjected to rotation compensation if needed, and the original image 101 is outputted to the color image transform unit 212.

When the predetermined information is embedded using the relative angle of the basic pattern 107 and the additional pattern 108, the rotation compensation is not necessarily performed to the original image 101.

The color image transform unit 212 detects the color of the pattern in the original image 101, and performs color transformation according to the color detected. For example, the color image transform unit 212 transforms the original image 101 into CMY space when the dots of the color component (e.g., M component) in CMY space are detected in the pattern. In this case, the color image transform unit 212 outputs the images of two color components (e.g., C and M components), which are the color components (black dot components) to be detected in the color image of the pattern transformed into CMY space, to the pattern detecting unit 210.

On the other hand, when the dots of the color component (e.g., G component) in RGB space are detected in the pattern, the color image transform unit 212 does not perform color transformation to the original image 101. In this case, the color image transform unit 212 outputs the image of the color component (G component) to the pattern detecting unit 210 as the black dot component in RGB space.

In either case, which color component of the color image should be outputted to the pattern detecting unit 210 may be fixedly set up beforehand. Alternatively, it may be selected by the user by setting up the image processing device using the operation panel 205.

For example, the pattern detecting unit 210 has the hardware composition as showing in FIG. 17. As shown in FIG. 17, based on the image data received from the color image transform unit 212, the basic pattern detecting unit 251 detects the basic pattern 107. As the method of detection in this case, any of various conventional methods using a digital circuit to detect an image pattern may be used. For example, the known pattern matching method may be used. In this case, an image of the pattern indicating the basic pattern 107 is stored beforehand in the ROM 204b, and the basic pattern 107 is detected using the stored pattern image.

In addition, a pattern which matches a corresponding characteristic amount may be detected using the characteristic amount of the basic pattern 107. As the characteristic amount of the basic pattern 107, the distance between respective dots which constitute the basic pattern 107 may be used. The characteristic amount of each pattern in the original image 101 is computed, and the computed characteristic amount is compared with the characteristic amount of the basic pattern 107 which is stored beforehand in the ROM 204b. When a match occurs, it is determined that the basic pattern 107 is detected.

In this embodiment, the additional pattern 108 is constituted to include the basic pattern 107. Therefore, the basic pattern detecting unit 251 detects not only the basic pattern 107 but also the additional pattern 108.

When the relative angle of the basic pattern 107 and the additional pattern 108 is used to express the predetermined information, the pattern image or the characteristic amount is stored for every stage to which the angle is quantized, and the basic pattern 107 is detected using the stored information.

Subsequently, the pattern threshold determining unit 252 counts the total number of detection patterns which are detected as the basic pattern 107 (also the additional pattern 108 being included) by the basic pattern detecting unit 251. When the total number of the detection patterns is larger than a predetermined threshold value, the pattern threshold determining unit 252 determines that the basic pattern 107 is detected. The determination is performed by using counters, adders, etc. which are constituted by digital circuits.

The reason why the total number of the detection patterns is counted and the total number is compared with the predetermined threshold value is that a pattern contained as a noise may be detected as being the basic pattern 107 and such erroneous recognition should be avoided.

The basic pattern determining unit 253 extracts only the basic patterns 107 from the detection patterns and counts the number of the extracted basic patterns 107. In consideration of erroneous recognition, when the number of the extracted basic patterns 107 is larger than a predetermined threshold value, it is determined that the basic patterns 107 exist, and position information and angle information of the extracted basic patterns 107 are outputted to the information extraction processing unit 211.

The additional patterns 108 are also contained in the detection patterns. Therefore, the extraction of the basic patterns 107 from the detection patterns may be performed based on the difference between the basic pattern 107 and the additional pattern 108. Namely, the patterns each containing no dot 108d from among the detection patterns are determined as being the basic patterns 107.

The additional pattern determining unit 254 extracts only the additional patterns 108 from the detection patterns and counts the number of the extracted additional patterns 108. In consideration of erroneous recognition, when the number of the extracted additional patterns 108 is larger than a predetermined threshold value, it is determined that the additional patterns 108 exist, and position information and angle information of the extracted additional patterns 108 are outputted to the information extraction processing unit 211. The patterns each containing the dot 108d from among the detection patterns are determined as being the additional patterns 108.

The information extraction processing unit 211 receives the processing results of the pattern detecting unit 210, and extracts the predetermined information which is currently embedded in the original image 101.

When the predetermined information is embedded by using the array of the basic pattern 107 and the additional pattern 108, the information extraction processing unit 211 divides the base region 104 into the unit areas of a predetermined arrangement (e.g., the arrangement of unit areas in four columns and two rows in FIG. 8), and determines which of the basic pattern 107 and the additional pattern 108 is contained in each of the unit areas of the arrangement. After the pattern contained in each unit area in the arrangement is determined, the information extraction processing unit 211 assigns a predefined value to each of the basic pattern 107 and the additional pattern 108 (for example, data “0” for the former and data “1” for the latter), so that the digital information expressed by the array of the patterns concerned is acquired as the embedded information.

On the other hand, when the predetermined information is embedded by using the relative angle of the basic pattern 107 and the additional pattern 108, the information extraction processing unit 211 is adapted so that the digital information expressed by the relative angle is acquired as the embedded information. The relative angle may be defined by taking statistics of the relative angles of all the basic patterns 107 and the additional patterns 108, and using the relative angle value corresponding to the peak in the statistics.

When a numeric value of the difference in the stage between the angles of both the patterns is embedded as the predetermined information in the original image, the information can be extracted by the following formula:
v=|x-y|Mod360/60

where v denotes the value of the embedded information, x denotes the angle of the basic pattern, and y denotes the angle of the additional pattern. The notation Mod indicates a modular arithmetic. In this case, it is assumed that the angle is quantized every 60 degrees.

For example, if the angle of the basic pattern 107 is 0 and the angle of the additional pattern 108 is 60, the above-mentioned formula yields the value of the embedded information: v=|0-60|Mod360/60=1. This means that the digital value “1” is extracted as the embedded information.

The information extraction processing unit 211 outputs the extracted information to the system controller 204. The system controller 204 controls operation of the image processing device 10 according to the extracted information so that a predetermined process is carried out. The predetermined process performed by the system controller 204 is, for example, to make the original image into an illegible image and output such illegible image as a copy result, so that the copying of a confidential document or the like may be prevented.

Alternatively, the predetermined process performed by the system controller 204 may be to display the extracted information on the operation panel 205 and give a certain notification to the user. Since the embedded information containing 2 or more bits may be used, one of various controls can be carried out.

Next, the composition of an image processing device in another embodiment of the invention will be explained.

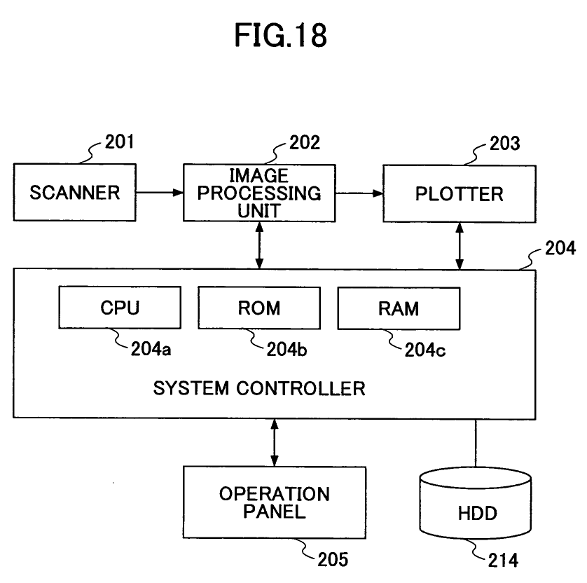

FIG. 18 shows the hardware composition of the image processing device of this embodiment.

In the previous embodiment of FIG. 16, the extracting processing of information from the original image is carried out by the hardware resources of the digital circuit. On the other hand, in the image processing device of this embodiment, the extracting processing of information from the original image is carried out by a computer program installed in the hardware resources of the image processing device.

In FIG. 18, the elements which are essentially the same as corresponding elements of the image processing device 10 in FIG. 16 are designated by the same reference numerals, and a description thereof will be omitted.

In the image processing device of FIG. 18, the pattern detecting unit 210, information extraction processing unit 211, the color image transform unit 212, and the selector 213 as in the previous embodiment of FIG. 16 are not provided in the image processing unit 202. However, the computer program (image processing program) for performing the extracting processing of information from the original image is recorded beforehand in the ROM 204b of the system controller 204 in this embodiment.

Alternatively, the image processing program may be installed in a HDD (hard disk drive) 214 which is connected via the bus to the microcomputer that is constituted by the CPU 204a, the ROM 204b and the RAM 204c, provided in the system controller 204 in this embodiment. The image processing program from the HDD 214 is written to the RAM 204c at the time of a startup of the image processing device, and the execution of the image processing program is performed by the CPU 204a.

In any case, the system controller 204 which constitutes a computer performs the execution of the extracting processing of information from the original image 101 in accordance with the computer program stored. In this meaning, the RAM 204c or the HDD 214 constitutes a computer-readable recording medium which has the computer program (the image processing program) stored therein.

Next, the composition of an image processing device in another embodiment of the invention will be explained.

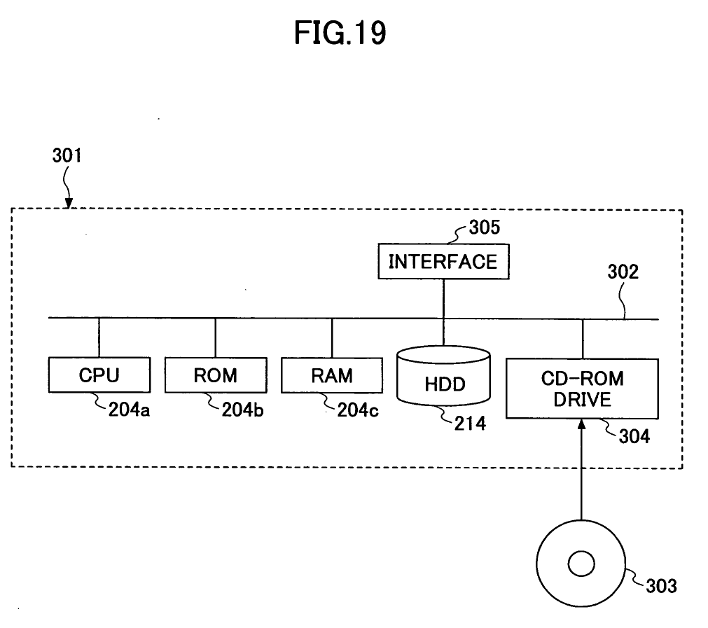

FIG. 19 shows the hardware composition of a personal computer which is the image processing device of this embodiment.

In the previous embodiment of FIG. 18, the image processing device performs the above-mentioned extraction processing by the computer program installed in the hardware resources of the image processing device. As previously described with reference to FIG. 16, this image processing device is provided in a digital copier.

However, it is not necessary that the extraction processing which extracts information from the original image is performed by the above-mentioned image processing device, and may be performed by using a general-purpose computer (e.g., a personal computer (PC)). In such a case, the computer program used by the general-purpose computer is essentially the same as the computer program used by the image processing device shown in FIG. 18.

As shown in FIG. 19, the personal computer 301, as the image processing device of this embodiment, comprises the CPU 204a which controls intensively the elements of the computer, and this CPU 204a is connected via the bus 302 to the ROM 204b, the RAM 204c, the HDD 214, a CD-ROM drive 304, and an interface 305 respectively. The CPU 204a, the ROM 204b and the RAM 204c form the microcomputer. The ROM 204b is a read-only memory in which the BIOS is recorded. The RAM 204c is a rewritable random-access memory in which various data are recorded and this RAM 204c functions as the work area of the CPU 204a. The computer program (the image processing program) is installed in the HDD 214. The CD-ROM drive 304 is used by the CPU 204a read out the data and programs from a CD-ROM 303. The interface 305 is used by the CPU 204a to communicate with a printer unit etc.

For example, the computer program which is the image processing program installed in the HDD 214 is originally recorded on the CD-ROM 303, and the computer program is read out by the CPU 204a using the CD-ROM drive 304 so that the computer program is installed in the HDD 214. When the computer program installed in the HDD214 is initiated, the computer program from the HDD 214 is copied to the RAM 204c so that the computer program is executed by the CPU 204a using the RAM 204c. In this meaning, the RAM 204c, the HDD 214, or the CD-ROM 303 functions as a computer-readable recording medium which has the computer program (the image processing program) stored therein.

As the computer-readable recording medium in which the computer program is recorded, any of various kinds of media, including magnetic disks, optical disks (not only the CD-ROM 303 but also DVD), magneto-optic disks, flexible disks, and semiconductor memories, may be used. The computer program may be downloaded from a network, such as the Internet, so that it is installed in the HDD 214. In this case, the storage device in which the computer program is recorded within the server of the transmitting side is also the computer-readable recording medium according to the invention. The computer program may operate on a predetermined OS (Operating System). In this case, the OS may take over execution of a part of the image processing program of the invention. The computer program may be contained as a part of a group of program files including a predetermined application program, such as a word-processing program, the OS, etc.

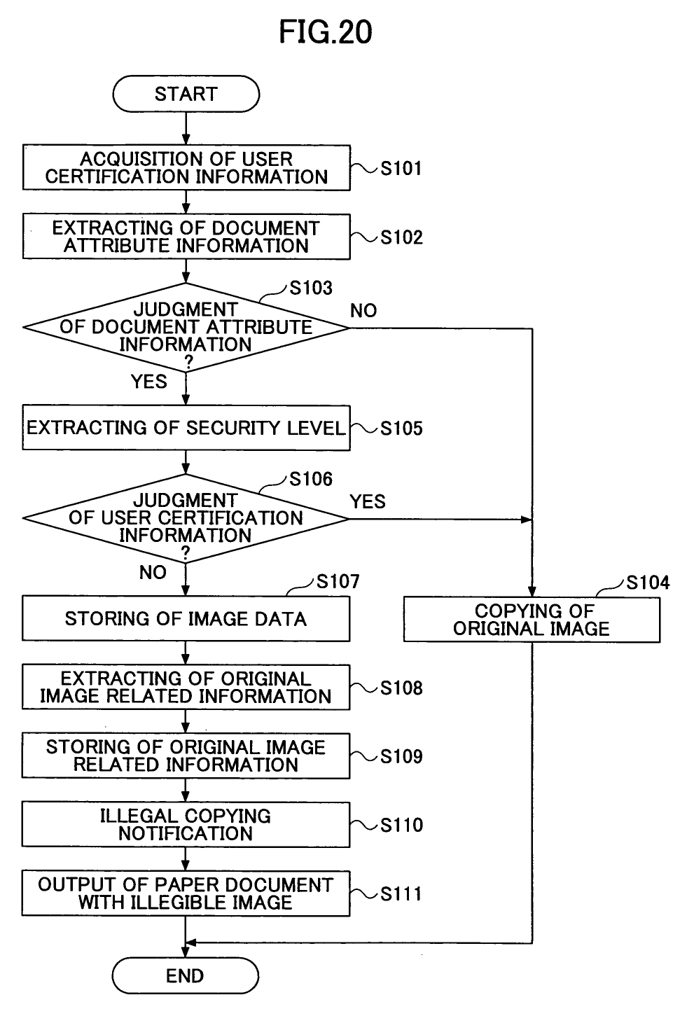

The processing performed by the personal computer 301 in accordance with the computer program installed in the HDD 214 is illustrated in the flowchart of FIG. 20. However, the personal computer 301 does not have the scanner 201. Therefore, the image data will be inputted to the personal computer 301 externally from a scanner connected via the network or the cable.

In the case of the above-described image processing device, the system controller 204 of FIG. 16 or FIG. 18, the CPU 204a, the ROM 204b, and the RAM 204c of FIG. 19 correspond to the attribute judgment unit, the certification-information acquisition unit, and the control unit. The plotter 203 corresponds to the printing unit. The HDD 214 corresponds to the storage unit.

Next, the processing performed by the above-described image processing device will be explained with reference to FIG. 20.

FIG. 20 is a flowchart for explaining the processing performed by the image processing device of the invention (the CPU 204a) according to the information embedded in the original image. It is supposed that the original image is read by a user who is authorized to copy or reproduce the original image.

In the flowchart of FIG. 20, the CPU 204a at step S101 performs a certification information acquisition process which acquires certification information including the user's attribute. The certification information is used to determine whether image reproduction of the original image (confidential document) by the user concerned is permitted.

The certification information mentioned above is certification information which includes an attribute of the user containing a user title, a user identifier, affiliation information indicating an affiliation company and a group to which the user pertains, and device identification information indicating an image forming device which performs image formation, etc. The image reproduction mentioned above includes the processing of copiers, facsimiles, scanners, etc. and the processing to store an image in a folder etc.

For example, the certification information acquisition process of the step S101 may be the processing which acquires the certification information including the user's attribute, when the user causes the card reader (provided in the image processing device) to read the card (assigned to the user concerned).

Alternatively, the user may be registered beforehand in the image processing device, and when the user inputs a log-in request to the image processing device, the certification information acquisition process which acquires the certification information including the user's attribute may be performed.

Next, the CPU 204a at step S102 performs a confidential-document information extracting process. This processing is the processing which extracts the information indicating whether the original image (the paper document) is an image of confidential document. The information extraction processing unit 211 of the image processing device extracts the predetermined information from the original image in which the predetermined information is embedded, and the system controller 204 acquires such extracted information.

Next, the CPU 204a at step S103 performs an attribute judgment process which determines whether the original image is an image of confidential document, based on the extracted information (the attribute of the paper document). The attribute judgment process of the step S103 corresponds to the attribute judgment unit.

When the original image is not the image of confidential document at the step S103, the problem of illegal copying does not arise. In this case, the CPU 204a at step S104 performs an image reproduction process which copies the original image. After the step S104 is completed, the processing of FIG. 20 is terminated.

On the other hand, when the original image is determined as being the image of confidential document at the step S103, the CPU 204a at step S105 performs a security level extracting process which acquires the information, indicating the security level, from the predetermined information of the original image (the information embedded in the paper document).

This security level extracting process of the step S105 may be the processing which acquires the information indicating the security level from an external device (e.g., a server etc.), based on the predetermined information of the original image.

This security level is comparing with the certification information, and it is used to determine whether the image reproduction of the confidential document is permitted for the user.

For example, in a case where the certification information is the user title, the security level is set to “top secret”, “second secret”, etc. And the security level in this case indicates that the image reproduction is permitted, if the certification information of the user indicates the president or the manager.

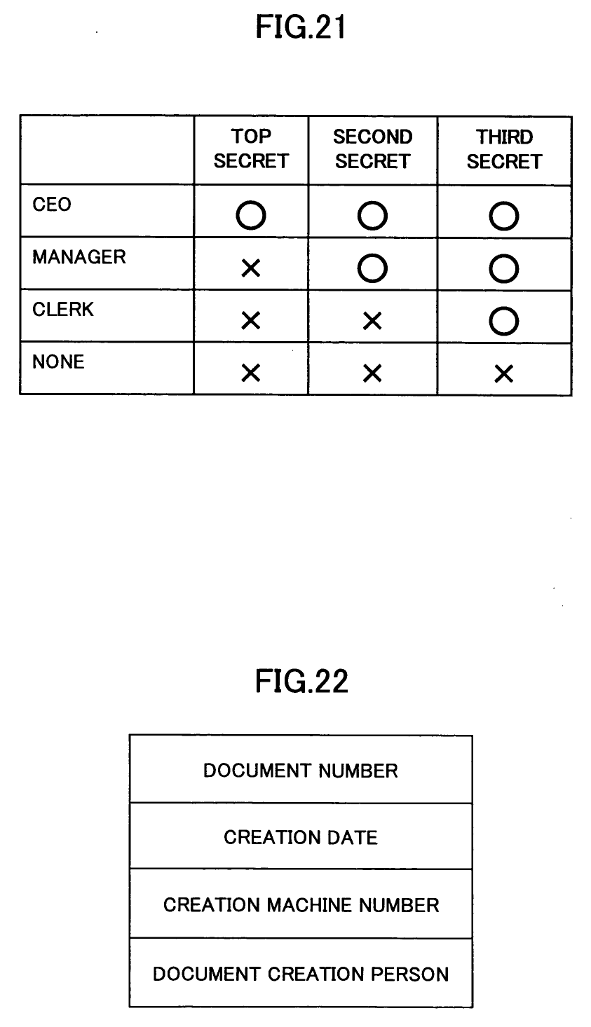

Next, the CPU 204a at step S106 performs a certification-information judgment process using the security level and the certification information. FIG. 21 shows an example of a table used in the certification information judgment process. In the table of FIG. 21, “top secret”, “second secret” and “third secret” of the horizontal axis indicate the respective security levels, and “CEO”, “manager”, “clerk” and “none” of the vertical axis indicates the certification information. In the table of FIG. 21, “O” indicates that the image reproduction is permitted for the user concerned, and “X” indicates that the image reproduction is not permitted for the user concerned.

Therefore, when the security level is “top secret”, the image reproduction is permitted only for the user who is “president”, and when the security level is “second secret”, the image reproduction is permitted for the user who is “president”, “manager” or “clerk”.

In this manner, at the step S106, it is determined whether the image reproduction of the original image is permitted for the user, by using the user's certification information and the security level. The process of the step S106 corresponds to the certification-information acquisition unit.

In addition, the certification-information judgment process of the step S106 may be configured so that not only the authentication of the user who read out the paper document, but also the authentication of an image forming device which performs image formation may be performed.

For example, in a case of a facsimile device, it is conceivable that the authentication of the facsimile device is performed using the device information (e.g., fax number) of the facsimile device which outputs the image information received by the facsimile device. When it is determined at the step S106, based on the certification information including the attribute of the user who caused the facsimile device to read the paper document, that the image reproduction is not permitted for the user concerned, the facsimile transmission of the original image from the facsimile device is inhibited, or the processing of outputting a gray image instead of the original image is performed.

In addition, the certification-information judgment process of the step S106 may be configured so that the authentication of the user and the authentication of the image forming device may be performed simultaneously.

For example, in a case of a facsimile device, it is conceivable that the authentication of the user who outputs the image information received by the facsimile device, and the authentication of the device information (fax number) of the facsimile device which receives the image information are performed simultaneously.

Moreover, in a case of a scanner device, it is conceivable that the authentications of the device information of the transmitting device which transmits the original image read by the scanner device, and of the device information (an e-mail address, a folder attribute, etc.) of the receiving device which receives the original image are performed.

The above-described certification-information judgment process is performed at the step S106.

When it is determined at the step S106 that the image reproduction is permitted, the problem of illegal copying does not arise. In this case, the image reproduction processing of copying the original image is performed at the step S104. After the step S104 is completed, the processing of FIG. 20 is terminated.

On the other hand, when it is determined at the step S106 that the image reproduction is not permitted, the CPU 204a at step S107 stores the image data of the original image into the storage unit, such as a hard disk, a flash memory, a NV-RAM.

Next, the CPU 204a at step S108 extracts the original-image-related information from the original image. FIG. 22 shows an example of the original-image-related information which relates to the paper document.

As shown in FIG. 22, the original-image-related information comprises a document number, a creation date, a creation machine number, and a document creation person. The document number is an ID which identifies the original image, and a unique ID is assigned to each original image. The creation data is the date the original image was created. The creation machine number is, for example, a machine serial number which identifies the machine which produced the original image. The document creation person is, for example, a user's ID which identifies the user who created the document concerned.

The above-mentioned original-image-related information is extracted at the step S108. Next, the CPU 204a at step S109 stores the original-image-related information into the storage device. The processing of the step S109 corresponds to the step of storing the original-image-related information into the storage unit.

Next, the CPU 204a at step S110 performs a notification process which notifies that illegal copying of the paper document the image reproduction of which is inhibited is performed. For example, in the notification process of the step S110, an e-mail reporting that illegal copying is performed may be transmitted from the image processing device concerned to a PC with the system administrator's address. Alternatively, in the notification process of the step S110, a message indicating that illegal copying is performed may be displayed on the operation panel 205 (FIG. 16) of the image processing device concerned. Or, in the notification process of the step S110, an alarm sound indicating that illegal copying is performed may be generated in the image processing device concerned. The above-mentioned e-mail may be transmitted together with a file of the stored image data attached to the e-mail.

Next, the CPU 204a at step S111 outputs a paper document in which the original image is made into an illegible image. After the step S111 is completed, the processing of FIG. 20 is terminated. The processing of the step S111 corresponds to the image outputting step.

According to the above-described processing, not only the prevention of illegal copying but also the notification of occurrence of illegal copying can be attained. Namely, the system administrator is able to know what kind of original image has been copied illegally and who has conducted illegal copying. Therefore, a further restraining effect to prevent copying of confidential document mentally can be created.

The present invention is not limited to the above-described embodiments, and variations and modifications may be made without departing from the scope of the present invention.

Further, the present application is based on and claims the benefit of priority of Japanese patent application No. 2005-182297, filed on Jun. 22, 2005, and Japanese patent application No. 2006-150409, filed on May 30, 2006, the entire contents of which are hereby incorporated by reference.

What is claimed is:

1. An image processing device which extracts predetermined information from a paper document in which the predetermined information is embedded, and performs a predetermined process in accordance with the extracted information, the image processing device comprising:
an attribute judgment unit determining an attribute of the paper document from the extracted information;
a certification-information acquisition unit acquiring certification information; and
a control unit performing a predetermined process based on the attribute of the paper document and the certification information.

2. The image processing device according to claim 1 wherein the image processing device is provided with a storage unit storing image data of an image of the paper document.

3. The image processing device according to claim 1 wherein, when it is determined, based on the attribute of the paper document and the certification information, that performance of the predetermined process to the paper document is inhibited, the control unit is provided to output an image of the paper document which is made illegible.

4. The image processing device according to claim 2 wherein the predetermined information includes original-image-related information which relates to the paper document, and the control unit is provided to store the original-image-related information into the storage unit.

5. The image processing device according to claim 1 wherein the attribute of the paper document includes a security level which is indicative of whether performance of the predetermined process is inhibited or not, in accordance with the certification information, and the control unit is provided to determine whether performance of the predetermined process to the paper document is inhibited, based on the security level and the certification information.

6. The image processing device according to claim 1 wherein, when it is determined that performance of the predetermined process to the paper document is inhibited, the control unit is provided to perform a predetermined notification.

7. An image processing method for an image processing device which extracts predetermined information from a paper document in which the predetermined information is embedded, and performs a predetermined process in accordance with the extracted information, the image processing method comprising the steps of:
determining an attribute of the paper document from the extracted information;
acquiring certification information; and
performing a predetermined process based on the attribute of the paper document and the certification information.

8. The image processing method according to claim 7 wherein the image processing device is provided with a storage unit storing image data of an image of the paper document.

9. The image processing method according to claim 7 wherein, when it is determined, based on the attribute of the paper document and the certification information, that performance of the predetermined process to the paper document is inhibited, the step of performing the predetermined process is provided to output an image of the paper document which is made illegible.

10. The image processing method according to claim 8 wherein the predetermined information includes original-image-related information which relates to the paper document, and the step of performing the predetermined process is provided to store the original-image-related information into the storage unit.

11. The image processing method according to claim 7 wherein the attribute of the paper document includes a security level which is indicative of whether performance of the predetermined process is inhibited or not, in accordance with the certification information, and the step of performing the predetermined process is provided to determine whether performance of the predetermined process to the paper document is inhibited, based on the security level and the certification information.

12. The image processing method according to claim 7 wherein, when it is determined that performance of the predetermined process to the paper document is inhibited, the step of performing the predetermined process is provided to perform a predetermined notification.

13. A computer-readable program which, when executed by a computer, causes the computer to perform an image processing method for an image processing device which extracts predetermined information from a paper document in which the predetermined information is embedded, and performs a predetermined process in accordance with the extracted information, the method comprising:
determining an attribute of the paper document from the extracted information;
acquiring certification information; and
performing a predetermined process based on the attribute of the paper document and the certification information.

14. A computer-readable recording medium storing the computer-readable program of claim 13 therein which, when executed by the computer, causes the computer to perform the image processing method for the image processing device which extracts the predetermined information from the paper document in which the predetermined information is embedded, and performs the predetermined process in accordance with the extracted information.
